(19) United States
(12) Patent Application Publication
(10) Pub. No.: US 2011/0177473 A1
(43) Pub. Date: Jul. 21, 2011

(54) DISPOSABLE DENTAL HANDPIECE

(75) Inventors: Saied Mohamed Hassan Darwish, Riyadh (SA); Gamal Mohamed Hassan Darwish, Alexandria (EG); Abdelnasser K. Daoud, Riyadh (SA)

(73) Assignee: King Saud University, Riyadh (SA)

(21) Appl. No.: 13/120,919

(22) PCT Filed: Oct. 21, 2008
(86) PCT No.: PCT/IB2008/002812

§ 371 Date: Mar. 24, 2011

(51) Int. Cl. A61C 3/02; B23P 17/04; B29C 45/14; B29C 65/48

(52) U.S. Cl. 433/117; 29/428; 264/250; 156/292

(57) ABSTRACT

A disposable dental handpiece, including a first handle portion; a second handle portion; a vibration dampening portion, the vibration dampening portion located interposed between the first handle portion and the second handle portion. In another embodiment, a multi-layer disposable dental handpiece, including a first layer of material having an outer surface defining a first outer surface portion of the multi-layer disposable dental handpiece; a second layer of material having an outer surface defining a second outer surface portion of the multi-layer disposable dental handpiece; a layer of vibration dampening material located interposed between the first and second layer of material defining a third outer surface portion of the multi-layer disposable dental handpiece. In yet another embodiment, methods for making a disposable dental handpiece are described.

### CROSS-REFERENCE TO RELEATED APPLICATIONS

This application is the US National Stage application of International Application No. PCT/IB2008/002812 filed Oct. 21, 2008, which is incorporated herein by reference.

### BACKGROUND

Conventional high speed dental handpieces are one piece assemblies having an integrally coupled hand portion and head assembly. A rotary turbine is typically located in the head assembly that accepts drilling tools for drilling teeth of a patient.

The rotary action of the turbine turns the drilling tool, such as a burr, which is attached to an axle of the turbine. The turbine is driven at high speeds of approximately 150,000 to 300,000 rpm by compressed air applied to the turbine. Air and water are delivered to the head assembly of the handpiece through tubing or passageways in the handle connected to a conventional dental stand which provides compressed air and water to the handpiece.

Conventional high speed dental handpieces are difficult to clean. In the process of drilling organic matter, bacterial residue enters the head assembly of the handpiece and becomes attached to the integral interior parts of the handpiece. The buildup of foreign matter on these interior parts of the handpiece presents two problems: first, the organic matter and bacterial residue and any diseases therein maybe transmitted to other dental patients by the force of the compressed air applied to the turban; and second, the buildup of foreign matter on the integral parts of the handpiece eventually reduces the speed at which the handpiece operates to an extent that the handpiece becomes nonfunctional and must be replaced. Cleaning the integral interior parts of the handpiece is generally not possible through normal disinfectant and sanitizing procedures such as rinsing or flushing. Autoclaving has been used to clean dental handpieces; however, autoclaving has been proven extremely time consuming and causes severe deterioration of the handpiece thereby lessening the usable lifespan of the device.

### SUMMARY

The above-described problems are solved and a technical advance achieved by the present disposable dental handpiece. In one embodiment, the present disposable dental handpiece includes a first handle portion; a second handle portion; and a vibration dampening portion, the vibration dampening portion located interposed between the first handle portion and the second handle portion. In one aspect, the first handle portion, second handle portion, and vibration dampening portion each have a longitudinal axis substantially commonly axially aligned. In another aspect, the disposable dental handpiece further includes a drill head assembly disposed at one end of the disposable dental handpiece, the drill head assembly extending from of at least one of the first handle portion, second handle portion, and vibration dampening portion. Further, the disposable dental handpiece may include at least one of a compressed air passageway, an exhaust air passageway, a water passageway, a light source passageway, and a vacuum source passageway extending longitudinally through the disposable dental handpiece. Additionally, a portion of the at least one of the compressed air passageway, exhaust air passageway, water passageway, light source passageway, and vacuum source passageway is formed in at least two of the first handle portion, second handle portion, and vibration dampening portion. Also, the outer surface of the disposable dental hand comprises the outer surfaces of the first handle portion, the second handle portion, and the vibration dampening portion.

In another embodiment, the present invention includes a multi-layer disposable dental handpiece including a first layer of material having an outer surface defining a first outer surface portion of the multi-layer disposable dental handpiece; a second layer of material having an outer surface defining a second outer surface portion of the multi-layer disposable dental handpiece; and a layer of vibration dampening material located interposed between the first and second layer of material defining a third outer surface portion of the multi-layer disposable dental handpiece. In one aspect, the multi-layer disposable dental handpiece may further include at least one of a compressed air passageway an exhaust air passageway, a water passageway, a light source passageway, and a vacuum passageway extending through the longitudinal axis of the disposable dental handpiece. In another aspect, the first handle portion, the second handle portion, and the vibration dampening portion are joined with an adhesive. Additionally, the vibration dampening portion is a material selected from the group consisting of polyvinylchloride, rubber, polyvinylchloride, PVC/rubber, thermoplastics, rubber-type materials, natural rubber, and synthetic rubber. Also, the first handle portion and the second handle portion are a material selected from the group consisting of high polymer synthetics, fluorocarbon resins, nylons, phenolics, polyimides, silicones, engineered plastics, acetals, polycarbonates, ABS resins, PPO/styrene, and polybutylene terephthalate. In yet another aspect, the first handle portion, the second handle portion, and the vibration dampening portion are a non-metal.

In yet another embodiment, the present invention includes a method for making a disposable dental handpiece including forming a first handle portion, a second handle portion, and a vibration dampening handle portion; and joining the vibration dampening handle portion interposed between the first handle portion and the second handle portion to make the disposable dental handpiece. In one aspect, the forming further includes forming the first handle portion, the second handle portion, and the vibration dampening handle portion in an injection mold. In another aspect, the joining further includes applying an adhesive to the adjacent surfaces of the first handle portion, the second handle portion, and the vibration dampening handle portion. In still yet another aspect, the joining may further include applying pressure to the first handle portion, the second handle portion, and the vibration dampening handle portion. Additionally, the forming may further include forming passageways through the longitudinal axis of the disposable dental handpiece prior to joining them together. The forming may also include forming passageways in the longitudinal axis of the disposable dental handpiece prior to joining them together in the injection mold. The forming passageways may also include providing relief sections in a mold of the injection molding apparatus, such that the relief sections partially produce the passageway in one of more of the first handle portion, the second handle portion, and the vibration dampening handle portion. In still yet another aspect, the forming may include forming a drilling head assembly with one or more of the first handle portion, the second handle portion, and the vibration dampening handle portion.

This Summary is provided to introduce a selection of concepts in a simplified form further described below in the detailed description. This Summary is not intended to identify key features or essential features of the claimed subject matter, nor is it intended to be used as an aid in determining the scope of the claimed subject matter. Additional features, advantages, and embodiments of the methods for preserving and restoring cranial bone flap are set forth or apparent from consideration of the following detailed description, drawings, and claims. Moreover, it is to be understood that both the foregoing Summary and the following detailed description are exemplary and intended to provide further explanation without limiting the scope of the disposable dental handpiece as claimed.

### BRIEF DESCRIPTION OF THE DRAWINGS

For a more complete understanding of the features and advantages of the present disposable dental handpiece, reference is now made to the detailed description of the disposable dental handpiece along with the different figures refer to corresponding parts and in which:

FIG. 1 shows a perspective view of a disposable handpiece with supply lines and drilling tool according to an embodiment of the present invention;

FIG. 2 illustrates another perspective view of the disposable dental handpiece without the drilling tool and supply lines according to an embodiment of the present invention;

FIG. 3 illustrates a side view of the disposal dental handpiece in accordance with an embodiment of the present invention;

FIG. 4 illustrates a cross-section view of the disposal dental handpiece through the cut lines 4-4 of FIG. 3 according to an embodiment of the present invention;

FIG. 5 illustrates an exploded perspective view of the disposable dental handpiece according to an embodiment of the present invention;

FIG. 6 illustrates an exploded side view of the disposable dental handpiece according an embodiment of the present invention;

FIG. 7a illustrates a exposed view of a molding apparatus for making a disposable dental handpiece according an embodiment of the present invention; and

FIG. 7b illustrates a top view of the molding apparatus as shown in FIG. 7a according to an embodiment of the present invention.

### DETAILED DESCRIPTION

While making and using of various embodiments of the present disposable dental handpiece are discussed in detail below, it should be appreciated that the present invention provides many applicable inventive concepts which can be embodied in a wide variety of specific contexts. The specific embodiments discussed herein are merely illustrative of specific ways to make and use the invention and do not delimit the scope of the present invention.

In the following description of the representative embodiments of the disposal dental handpiece, directional terms such as “above,” “below,” “upper,” “lower,” etc., are used for convenience in referring to the accompanied drawings. In general, “above,” “upper,” “upward” and similar terms refer to a direction that is commonly thought of as vertically upward and the terms “below,” “lower,” and “downward” and similar terms refer to a direction in the opposite direction or vertically downward as commonly known. For purposes of this discussion, the relativity of these terms may be thought of in the context of the use and operation of the present disposable dental handpiece. For example, during normal operation of the present disposable dental handpiece, the disposable dental handpiece may be operated such that the drilling tool may be pointing downward or upward. Thus, for purposes of this discussion and in one embodiment, the description herein is described with relevance of the disposable dental handpiece in a position such that the drilling tool is pointing downward.

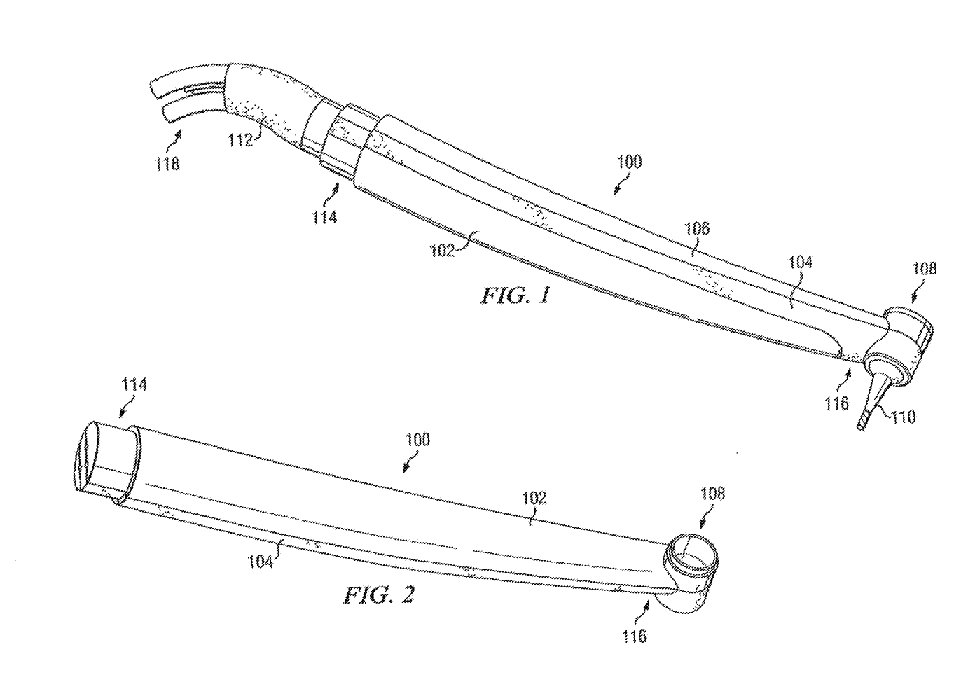

Referring initially to FIGS. 1-3, a disposable dental handpiece is illustrated and generally designated 100. Disposable dental handpiece 100 includes a generally cylindrically shaped exterior extending from the supply line end 114 to the neck end 116. This generally cylindrical shape may have other forms such as ergonomic forms or any other polygonal forms as commonly known in the art. Disposable dental handpiece 100 may also have a tapered shape, such that it has one diameter at supply line end 114 tapering to a smaller diameter at neck end 116, as shown in FIG. 1. Preferably, disposable dental handpiece 100 includes a first handle portion 102, a second handle portion 106, and a vibration dampening portion 104 interposed between first handle portion 102 and second handle portion 106.

First handle portion 102, vibration dampening portion 104, and second handle portion 106 generally all share generally a common longitudinal axis. The first handle portion 102, vibration dampening portion 104, and second handle portion 106 form a multi-layered body, each portion or layer extending from one side of the disposal dental handpiece to the other side of disposal dental handpiece 100, as shown in FIGS. 1-3. In addition, in one embodiment, disposable dental handpiece 100 may also have a longitudinally curved shape to it. For example, as shown in FIGS. 1-3, this curved shape may extend and gradually curve from supply line end 114 toward neck end 116 of disposal dental handpiece 100. The tapered and curved shape of disposable dental handpiece 100 are formed by the outer surfaces of the first handle portion 102, vibration dampening portion 104, and second handle portion 106.

Referring now to FIGS. 1, 3, 5, and 6 and in one embodiment, first handle portion 102 preferably extends from supply line end 114 nearly to the neck end 116. In this embodiment, second handle portion 106 preferably extends from supply line end 114 to neck end 116, and vibration dampening portion 104 extends from supply line end 114 to neck end 116. In another aspect, first handle portion 102 may extend fully from supply line end 114 to neck end 116. In another embodiment, the vibration dampening portion 104 and second handle portion 106 may extend nearly to neck end 116. Preferably, vibration dampening portion 104 is located between first handle portion 102 and second handle portion 106. In another embodiment, vibration dampening portion 104 may be located in a different layer relative to first handle portion 102 and/or second handle portion 106. Additionally, other additional layers not shown here may also be used with disposal dental handpiece 100.

Continuing reference to FIG. 1, second handle portion 106 and vibration dampening portion 104 may terminate at the neck end 116 to form drill head assembly 108. In another embodiment, first handle portion 102, vibration dampening portion 104 and second handle portion 106 may all terminate in drill head assembly 108. In yet another aspect, any of the first handle portion 102, vibration dampening portion 104, and second handle portion 106 may terminate and form drill head assembly 108, while the others may form or not form partially or fully drill head assembly 108.

Drill head assembly 108 may include a rotary member (not shown) that is rotatably seated within drill head assembly 108. Rotary member may include turbine blades that are coupled to and rotate with a central shaft of the rotary member, which is connected to a rotary bit, such as drilling tool 110. The drill head assembly 108 and rotary member may include bushings, seals, bearings, and the like to facilitate the high speed rotation of rotary member. As would be understood by one skilled in the art, rotary member is generally driven by compressed air that is fed through disposable dental handpiece as further described herein.

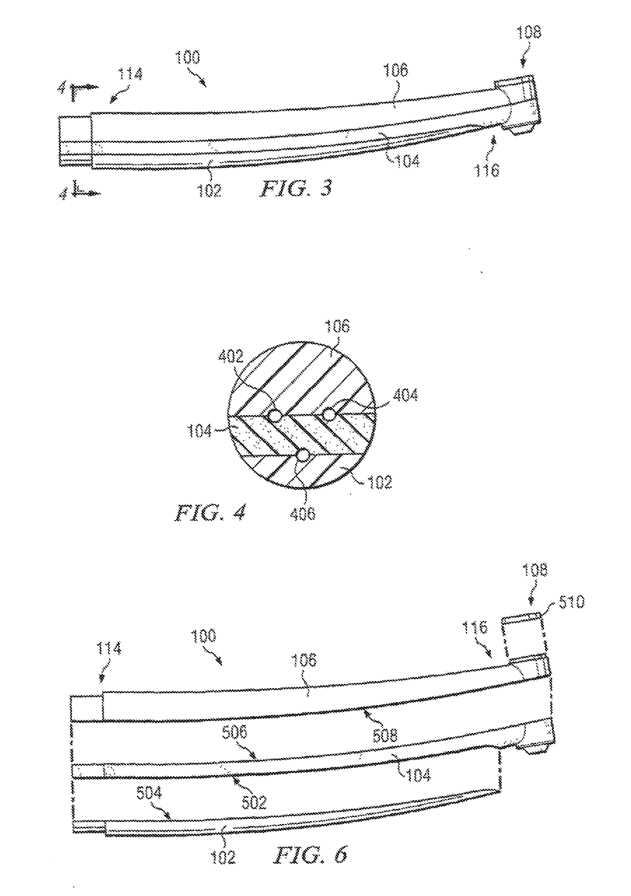

Disposable dental handpiece 100 may further include a connector 112 for connecting air, water and exhaust supply lines (collectively supply lines 118) to the supply end 114 of disposable dental handpiece 100. Disposable dental handpiece may further include additional supply lines 118, such as a vacuum line and/or a fiber optic line for providing light at the worksite of the drilling tool 110. Supply lines 118 provide the compressed air and noncompressed air, water, exhaust, light source, and vacuum to the supply line end 114 of disposable dental handpiece 100, which are transmitted through the disposable dental handpiece 100 by passageways as further described herein, for providing the same to the drill head assembly 108 of disposable dental handpiece 100. With reference to FIGS. 2-3, disposable dental handpiece 100 is shown with drilling tool 110 removed from drill head assembly 108 and connector 112 and supply lines 118 removed from supply line end 114 of disposable dental handpiece 100.

Referring now to FIG. 4, a cross sectional view of disposable dental handpiece 100 is shown through the cut lines 4-4 of FIG. 3 toward the end of supply line end 114. As shown in FIG. 4, first handle portion 102 extends from one side of disposable dental handpiece 100 to the other side of disposal dental handpiece 100 and has a curved lower surface area. In addition, second handle portion 106 is shown extending from one side of disposable dental handpiece 100 to the other side of disposable dental handpiece 100 with an upper curve surface area. Interposed between these two portions is vibration dampening portion 104 extending from one side of disposable dental handpiece to the other side of disposable dental handpiece 100. In this embodiment, vibration dampening portion 104 is shown to have a curved outer portion located between first handle portion 102 and second handle portion 106. As discussed above, these upper and lower curved surface areas are described with reference to disposable dental handpiece 100 be operated or positioned with drilling tool 110 pointed downward. These relative terms may be otherwise reversed when describing disposable dental handpiece 100 being operated or positioned with drilling tool 110 pointed upward, as would be commonly understood in the art.

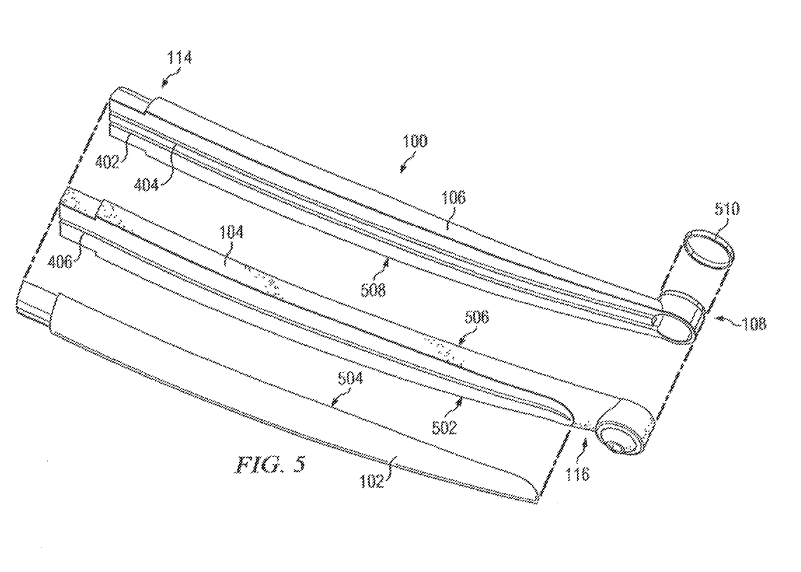

First handle portion 102 has a substantially flat or planar upper surface where it is adjacent and joined to vibration dampening portion 104, which itself has a flat or planar lower surface. Likewise, the upper surface of vibration dampening portion 104 has a flat or planar surface where it is adjacent or joined with second handle portion 106 which also has a flat or planar surface where it joins the upper surface of vibration dampening portion 104. These surface are described further in reference to FIG. 5.

Continuing with reference to FIG. 4, three passageways are shown. An air inlet passageway 402, an air exhaust passageway 404, and a water passageway 406 all which extend from supply line end 114 to drilling head 108 and/or neck portion 116 of disposable dental handpiece 100. Although three passageways are shown, it should be understood by one skilled in the art that additional passageways may be formed in disposable dental handpiece 100, such as a passageway for a light source and a passageway for a vacuum source, for example. In one embodiment, a portion of air inlet passageway 402 and air exhaust passageway 404 is formed in the lower area of second handle portion 106. Additionally, a portion of air inlet passageway 402 and air exhaust passageway 404 is also formed in a portion of vibration dampening portion 104 of disposable dental handpiece 100.

Likewise, water passageway 406 is partially formed in the lower area of vibration dampening portion 104 and the upper area of first handle portion 102, for example. It should be apparent to those skilled in the art that the precise location or disposition of areas in passageway 402, air exhaust passageway 404 and water passageway 406 where these passageways are located is a choice of design and in accordance with one embodiment. Many other variety of configurations, including configurations where each is located in another area or portion of air inlet passageway 402, air exhaust passageway 404 and/or water passageway 406 is considered within the scope of the present disposable dental handpiece 100.

With reference now to FIG. 5, first handle portion 102, vibration dampening portion 104, second handle portion 106 are shown in an exploded view. Further illustrated is an upper surface 504 of first handle portion 102 that is located adjacent to and joined to lower surface 502 of vibration dampening portion 104. Further, an upper surface 506 of vibration dampening portion 104 is located adjacent to and joined to a lower surface 508 of second handle portion 106. Although these surfaces are shown substantially planar, they may be any shape or form desired for ease of manufacturing or assembly.

Additionally, a water passageway 406 is formed on lower surface 502 of the vibration dampening portion 104. Water passageway 406 extends from the supply end 114 to the drilling head assembly 108 of disposable dental handpiece 100, as discussed above. As shown, air inlet passageway 402 and air exhaust passageway 404 are formed and extend from the supply line end 114 to the drill head assembly of disposable dental handpiece 100. In one aspect, air inlet passageway 402 provides compressed air from a dental station to the rotary member located within drill head assembly 108, and air exhaust passageway 404 returns the air after it has had driven rotary turbine within drilling head assembly 108. A cap 510 may be located on top of drill head assembly 108 for enclosing the rotary member within drill head assembly 108. In one example, cap 510 maybe secured to the drill head assembly 108 by fasteners, snap, and the like as is commonly known to those skilled in the art.

Generally, first handle portion 102, vibration dampening portion 104, and second handle portion 106 are manufactured or molded individually or separately and then assembled. For example, as further discussed below, in one embodiment, first handle portion 102 and second handle portion 106 maybe composed of the same or different materials while the vibration dampening portion 104 maybe composed of yet another type of material that is desirable for vibration dampening. Preferably, first handle portion 102 and second handle portion 106 are made from a relatively inexpensive, yet hard or rigid material that can be formed or molded to a desired shape, such as those illustrated. In one embodiment, this material may be a high polymer synthetic that may be combined with other ingredients such as curatives, fillers, reinforcing agents, colorants, plasticizers, and the like. The first handle portion 102 and second handle portion 106 material may be formed or molded under heat and pressure in its raw state and/or machined to high dimensional accuracy, trimmed and finished in its hardened state to form first handle portion 102 and second handle portion 106, for example. Some exemplary materials include plastics that may include fluorocarbon resins, nylon, phenolics, polyimides, and silicones. Additionally, the composition of first handle portion 102 and second handle portion 106 may be made from cellulosics, polyethylenes, acrylic polymers, polystyrene, and polyurethane. Additionally, engineered plastics may be used, such as those where standard metal engineering equations may be applied. They typically are capable of sustaining high loads in stresses and are machinable and dimensionally stable. Some exemplary engineered plastics include nylon, acetals, polycarbonates, ABS resins, PPO/styrene, and polybutylene terephthalate, for example.

Vibration dampening portion 104 is preferably composed of a moldable material that absorbs vibration created by the rotation of rotary member within drill head assembly 108 during use of disposable dental headpiece 100. Some exemplary materials that may be used for vibration dampening portion 104 include polyvinylchloride, rubber, polyvinylchloride, or PVC/rubber. Additionally, other thermoplastic or rubber type materials may be used. Preferably, the material that comprises the vibration dampening portion 104 may be a natural or synthetic high polymer that unique properties of deformation, elongation, yield under stress, or elastic recovery. Further, this material may be a natural and/or synthetic rubber composition or just a natural rubber or a synthetic rubber.

Once formed, first handle portion 102, vibration dampening portion 104, and second handle portion 106 may be joined together by an adhesive such as an inorganic, organic nature, and/or synthetic adhesive, for example. In one aspect, these portions may be joined together with a high temperature adhesive. In another aspect, these portions may be joined by a hot melt adhesive. Some exemplary hot melt adhesives may include compositions containing polyethylene, polyvinyl acetate, polyamides, hydrocarbon resins, as well as natural asphalts, bitumens, resinous materials, waxes or compositions and mixtures of these to make the hot melt adhesive. In yet another aspect, these portions may be joined together by a rubber based adhesive. In still yet another aspect, these portions may be joined together by pressure sensitive adhesives. By joining or bonding first handle portion 102, second portion 106, and vibration dampening portion 104 with an adhesive, such as a pressure sensitive adhesive, these portions bond together to provide good structural durability and good noise and vibration absorbing properties and characteristics of the disposable dental handpiece 100.

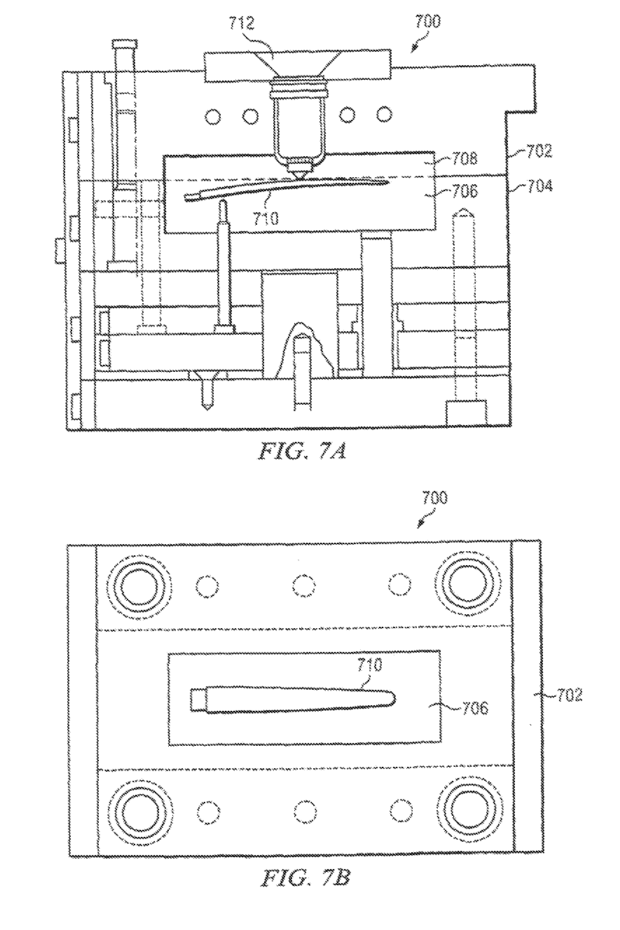

Referring now to FIGS. 7a and 7b, a molding apparatus 700 is shown. In one embodiment, molding apparatus 700 is an injection molding apparatus for making first handle portion 102, second handle portion 106, and/or vibration dampening portion 104. Molding apparatus 700 includes a lower mold section 706 and an upper mold section 708 that together form mold 710 for making first handle portion 102, second handle portion 106 and/or vibration dampening portion 104. Lower mold section 706 and upper mold section 708 are separate mold sections and are capable of being separated once a particular portion or layer of disposable dental handpiece 100 is molded for removing it from the molding apparatus 700. Additionally, molding apparatus 700 further includes an injection inlet 712 also know as a injection nozzle. Molding apparatus 700 may further include an upper mold apparatus section 702 and a lower mold apparatus section 704 for providing pressures and temperatures to the upper mold section 708, lower mold section 706, and mold 710, for example. Preferably, mold 710 has a form or shape of the desired shape of a particular portion or layer to be made, such as first handle portion 102. In one aspect, lower mold section 706 and upper mold 708 may be made from a prehardened steel aluminum or other type of durable material that can withstand the temperatures and pressures of the molding apparatus 700 when making first handle portion 102, second handle portion 106, and/or vibration dampening portion 104.

As shown, lower mold section 706 and upper mold section 708 are separated by what is known as a parting line to create at first side 708 upper mold section, and a second lower mold section 706, such that the molded portion or layer may be removed once its formed or molded. Additionally, lower mold section 706 and upper mold section 708 produce or form a mold 710 that has the desired relief in the shape of a particular passageway as described herein, such as air inlet passageway 402, air exhaust passageway 404, or water passageway 406, in addition to any other passageways that may be included with disposable dental handpiece 100.

In one embodiment, the selected or desired material for making the first handle portion 102, second handle portion 106, and/or vibration dampening portion 104 is prepared and injected into the mold 710 through the injection inlet 712. Once the material is injected into the mold 710, the molding apparatus may either be heated and/or pressurized to further form the desired portion or layer. For example, once the desired portion or layer is formed, the upper mold section 708 may be removed from the lower mold section 706, such that the molded portion or layer may be extracted from the mold 710.

Once the portions or layers have been molded, then additional steps may be taken such as finishing, polishing, trimming, and the like to prepare the pieces for joining. At this point, an adhesive, as discussed herein may be applied to one or all of the following surfaces: upper surface 504, lower surface 502, upper surface 506, and lower surface 508 of disposable dental handpiece 100. Then, first handle portion 102, second handle portion 106, and vibration dampening portion 104 are joined together and may be compressed with pressure to further make the disposable dental handpiece 100 as is commonly known in the art.

### CONCLUSION

The above-described exemplary embodiments of the disposable dental handpiece are presented for illustrative purposes only. While the disposable dental handpiece is satisfied by embodiments in many different forms, it is understood that the present disclosure is to be considered as exemplary and is not intended to limit the described systems and methods to the specific embodiments illustrated and described herein. Numerous variations may be made by persons skilled in the art without departure from the spirit of this description. Moreover, features described in connection with one embodiment may be used in conjunction with other embodiments, even if not explicitly stated above. The scope of the disposable dental handpiece will be measured by the appended claims and their equivalents. The abstract and the title are not to be construed as limiting the scope of the claims, as their purpose is to enable the appropriate authorities, as well as the general public, to quickly determine the general nature of the described disposable dental handpiece and methods. In the claims that follow, unless the term “means” is used, none of the features or elements recited therein should be construed as means-plus-function limitations pursuant to 35 U.S.C. §112, ¶6.

1. A disposable dental handpiece comprising:
a first handle portion;
a second handle portion; and
a vibration dampening portion, the vibration dampening portion located interposed between the first handle portion and the second handle portion.

2. The disposable dental handpiece of claim 1, wherein the first handle portion, second handle portion, and vibration dampening portion each have a longitudinal axis substantially commonly axially aligned.

3. The disposable dental handpiece of claim 1, further comprising:
a drill head assembly disposed at one end of the disposable dental handpiece, the drill head assembly extending from of at least one of the first handle portion, second handle portion, and vibration dampening portion.

4. The disposable dental handpiece of claim 1, further comprising:
at least one of a compressed air passageway, an exhaust air passageway, a water passageway, a light source passageway, and a vacuum source passageway extending longitudinally through the disposable dental handpiece.

5. The disposable dental handpiece of claim 4, wherein a portion of the at least one of the compressed air passageway, exhaust air passageway, water passageway, light source passageway, and vacuum source passageway is formed in at least two of the first handle portion, second handle portion, and vibration dampening portion.

6. The disposable dental handpiece of claim 1, wherein the outer surface of the disposable dental hand comprises the outer surfaces of the first handle portion, the second handle portion, and the vibration dampening portion.

7. A multi-layer disposable dental handpiece comprising:
a first layer of material having an outer surface defining a first outer surface portion of the multi-layer disposable dental handpiece;
a second layer of material having an outer surface defining a second outer surface portion of the multi-layer disposable dental handpiece; and
a layer of vibration dampening material located interposed between the first and second layer of material defining a third outer surface portion of the multi-layer disposable dental handpiece.

8. The multi-layer disposable dental handpiece of claim 7, further comprising:
at least one of a compressed air passageway, an exhaust air passageway, a water passageway, a light source passageway, and a vacuum passageway extending through the longitudinal axis of the disposable dental handpiece.

9. The multi-layer disposable dental handpiece of claim 7, wherein the first handle portion, the second handle portion, and the vibration dampening portion are joined with an adhesive.

10. The multi-layer disposable dental handpiece of claim 7, wherein the vibration dampening portion is a material selected from the group consisting of polyvinylchloride, rubber, polyvinylchloride, PVC/rubber, thermoplastics, rubber-type materials, natural rubber, and synthetic rubber.

11. The multi-layer disposable dental handpiece of claim 7, wherein the first handle portion and the second handle portion are a material selected from the group consisting of high polymer synthetics, fluorocarbon resins, nylons, phenolics, polyimides, silicones, engineered plastics, acetals, polycarbonates, ABS resins, PPO/styrene, and polybutylene terephthalate.

12. The multi-layer disposable dental handpiece of claim 7, wherein the first handle portion, the second handle portion, and the vibration dampening portion are a non-metal.

13. A method for making a disposable dental handpiece, the method comprising:
forming a first handle portion, a second handle portion, and a vibration dampening handle portion; and
joining the vibration dampening handle portion interposed between the first handle portion and the second handle portion to make the disposable dental handpiece.

14. The method of claim 13, wherein the forming further comprises:
forming the first handle portion, the second handle portion, and the vibration dampening handle portion in an injection mold.

15. The method of claim 13, wherein the joining further comprises:
applying an adhesive to the adjacent surfaces of the first handle portion, the second handle portion, and the vibration dampening handle portion.

16. The method of claim 13, wherein the joining further comprises:
applying pressure to the first handle portion, the second handle portion, and the vibration dampening handle portion.

17. The method of claim 13, wherein the forming further comprises:
forming passageways through the longitudinal axis of the disposable dental handpiece prior to joining them together.

18. The method of claim 14, wherein the forming further comprises:
forming passageways in the longitudinal axis of the disposable dental handpiece prior to joining them together in the injection mold.

19. The method of claim 17, wherein the forming passageways further comprises:
providing relief sections in a mold of the injection molding apparatus, such that the relief sections partially produce the passageway in one of more of the first handle portion, the second handle portion, and the vibration dampening handle portion.

20. The method of claim 13, wherein the forming further comprises:
forming a drilling head assembly with one or more of the first handle portion, the second handle portion, and the vibration dampening handle portion.
